(19) United States
(12) Patent Application Publication
(10) Pub. No.: US 2023/0148292 A1
(43) Pub. Date: May 11, 2023

(54) SYSTEM AND METHOD FOR REWARD-BASED COMPUTING SERVICES ON A DISTRIBUTED COMPUTING PLATFORM

(71) Applicant: Spawn Computing LLC, Scotts Valley, CA (US)

(72) Inventor: Fleming Shi, Scotts Valley, CA (US)

(21) Appl. No.: 17/979,951

(22) Filed: Nov. 3, 2022

Related U.S. Application Data
(60) Provisional application No. 63/277,018, filed on Nov. 8, 2021.

(51) Int. Cl. G06Q 30/02; G06Q 20/36

(52) U.S. Cl. CPC G06Q 30/0215; G06Q 20/36

(57) ABSTRACT

A service provider is configured to identify, register, and utilize a plurality of distributed computing resources/service nodes in the distributed computing platform to collectively provide/host a set of services to a plurality of service/application clients. Here, the plurality of service nodes are electronic devices owned or associated with a plurality of third-party service participants located at distinct geographical locations and are discoverable by the service provider over the Internet. The service provider is configured to intelligently route each request for a service from a service client to be served by one or more of the device nodes of a service participant. After the service has been delivered, the service provider tracks and generates one or more immutable proof-of-service receipts for the service provided by the service participant. A reward service then records and rewards the service participant for the service provided according to the proof-of-service receipts.

### CROSS-REFERENCE TO RELATED APPLICATIONS

This application claims the benefit of U.S. Provisional Pat. Application No. 63/277,018, filed Nov. 8, 2021, which is incorporated herein in its entirety by reference.

### BACKGROUND

In recent years, especially getting through the COVID-19 pandemic, the world is increasingly transforming into a digital-first era, where computing services including but not limited to web-based, communication, and storage services hosted by servers and accessible by various client devices (e.g., PCs and mobile devices) over the Internet dominate our livelihood and are essential to every industry. Conventionally, the servers hosting the computing services are located at centralized data centers or server farms while the client devices accessing the computing services are associated with individual users. Such centralized computing service platforms as well as human behaviors of the individual users, however, have led to overuse and waste of natural resources since a huge amount of computing resources/electronic devices that are perfectly functional are no longer being used simply because they are not the latest version, e.g., older generations of smart phones. Although a small number of these devices can be traded in and/or recycled, most of the computing resources remain idle and unutilized, leading to a tremendous waste of computing resources.

The foregoing examples of the related art and limitations related therewith are intended to be illustrative and not exclusive. Other limitations of the related art will become apparent upon a reading of the specification and a study of the drawings.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 depicts an example of a system diagram to support a reward-based distributed computing platform in accordance with some embodiments.

FIG. 2 depicts an example of components of the service provider engine in the example of FIG. 1 in accordance with some embodiments.

FIG. 3 depicts an example of components of the reward service engine in the example of FIG. 1 in accordance with some embodiments.

FIG. 4 depicts a flowchart of an example of a process to support a reward-based distributed computing platform in accordance with some embodiments.

### DETAILED DESCRIPTION OF EMBODIMENTS

The following disclosure provides many different embodiments, or examples, for implementing different features of the subject matter. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

A new approach is proposed to support a reward-based distributed computing platform. Here, a service provider is configured to identify, register, and utilize a plurality of distributed computing resources/service nodes in the distributed computing platform to collectively provide/host a set of services to a plurality of service/application clients, wherein the set of services include but are not limited to computing, communication, and storage services that are accessible by the plurality of clients. Here, the plurality of service nodes are electronic devices owned or associated with a plurality of third-party service participants located at distinct geographical locations and are discoverable by the service provider over the Internet. The service provider is configured to intelligent route each request for a service from a service client to be served by one or more of the device nodes of a service participant. After the service has been delivered, the service provider is configured to track and generate one or more immutable proof-of-service receipts for the service provided by the service participant. A reward service may then record and reward the service participant for the service provided according to the proof-of-service receipts.

The proposed approach enables a reward mechanism that identifies distributed computing resources and verifies proof of work or contract service delivered by the service participants via the service provider including the servicing time of each of the distributed computing resources. By capturing under-utilized computing resources that are already available and rewarding the community of service participants (e.g., owners of the currently unused computing devices) accordingly, the proposed approach aims at shifting wasteful behaviors and providing incentives to the service participants for providing their resources to serve other clients. Such reward mechanism can drive sustainability in computer resources (e.g., by making computing services greener) and change in human behavior (e.g., by encouraging service participants to stop mining and to start earning by serving others). In addition, given the decentralized and peer-to-peer nature of the distributed computing resources, the proposed approach increases resiliency of the computing services.

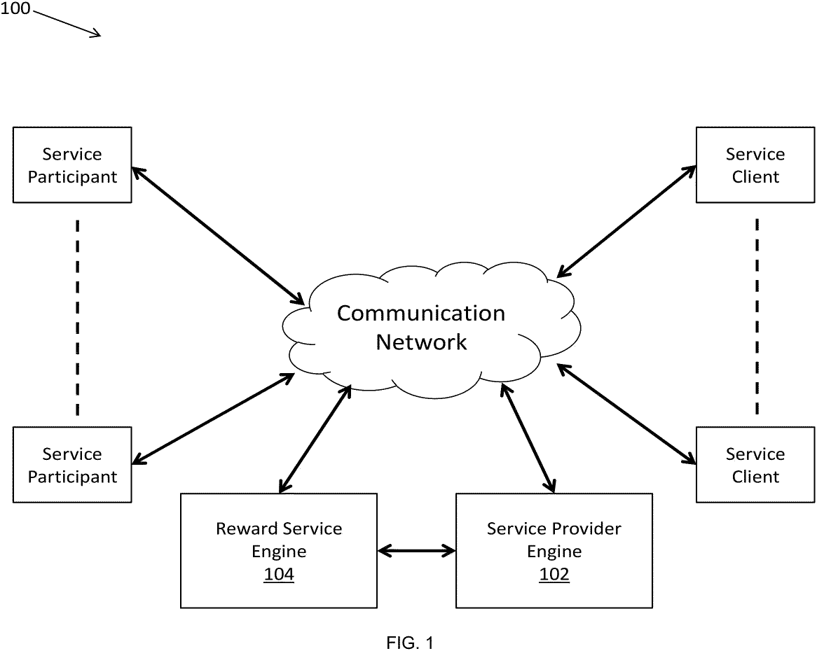

FIG. 1 depicts an example of a system diagram 100 to support a reward-based distributed computing platform. Although the diagrams depict components as functionally separate, such depiction is merely for illustrative purposes. It will be apparent that the components portrayed in this figure can be arbitrarily combined or divided into separate software, firmware, and/or hardware components. Furthermore, it will also be apparent that such components, regardless of how they are combined or divided, can execute on the same host or multiple hosts, and wherein the multiple hosts can be connected by one or more networks.

In the example of FIG. 1, the system 100 includes a service provider engine 102 and a reward service engine 104, wherein the service provider engine 102 and the reward service engine 104 interacts with a plurality of service participants and a plurality of service clients over a communication network. Each of the engines run on one or more computing units/appliances/devices/hosts (not shown) with software instructions stored in a storage unit, such as a non-volatile memory (also referred to as secondary memory) of the computing unit for practicing one or more processes. When the software instructions are executed, at least a subset of the software instructions is loaded into memory (also referred to as primary memory) by one of the computing units, which becomes a special purposed one for practicing the processes. The processes may also be at least partially embodied in the computing units into which computer program code is loaded and/or executed, such that the host becomes a special purpose computing unit for practicing the processes.

In the example of FIG. 1, each of the plurality of service participants and each of the service clients/consumers of computing services is associated with one of a computing device, a communication device, a storage device, and any electronic device capable of running a software component. For non-limiting examples, a computing device can be but is not limited to a server machine, a laptop PC, a desktop PC, a tablet, a Google Android device, an iPhone, an iPad, and a voice-controlled speaker or controller. In the example of FIG. 1, the communication network can be but is not limited to, Internet, intranet, wide area network (WAN), local area network (LAN), wireless network, Bluetooth, WiFi, and mobile communication network for internal communications among entities, components, and users of an organization. The physical connections of the communication network and the communication protocols are well known to those of skilled in the art.

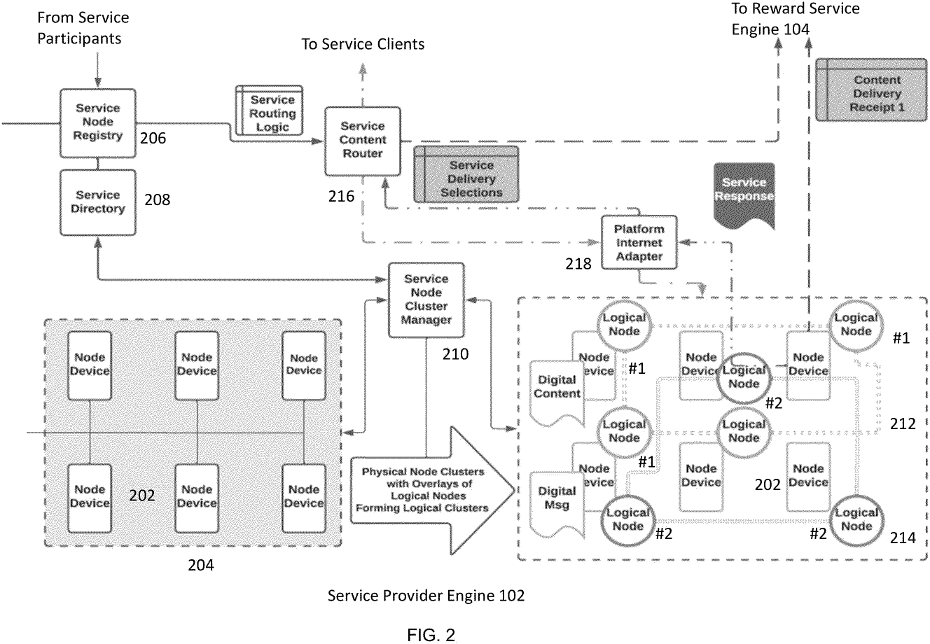

FIG. 2 depicts an example of components of the service provider engine 102 in the example of FIG. 1. As shown by the example of FIG. 2, the service provider engine 102 is configured to manage and operate a plurality of service nodes 202 each having one or more computing resources/node devices configured to provide one or more computing services. Here, each of the node devices can be one of a computing device, a communication device, a storage device, and an electronic device capable of running a software component as described above. In some embodiments, each of the service nodes 202 can be either physical or logical, wherein each of the node devices is configured to load software necessary to provide the one or more computing services. In some embodiments, the workload of a service node 202 is predefined by the selection of a service participant that owns the service node 202. In some embodiments, the service provider engine 102 has partial or no ownership of the computing resources, which are associated with and/or owned by one of the plurality of service participants instead. The one or more computing services provided by each of the plurality of service nodes 202 include but are not limited to web-based service (e.g., web server), Domain Name System (DNS), Software as a Service (SaaS), an Infrastructure as a Service (IaaS), a Platform as a Service (PaaS), media conversion service (e.g., image to text, voice to text, etc.), Short Message Service (SMS), ping test, and any other type of Internet-based service. In some embodiments, a service participant has a container app installed and running on the node devices of each of the service nodes 202 to manage and deliver the services without touching the rest of the computing resources/environment/data of the each of the node devices. Such container app provides an isolation strategy that reduces hacking and removes privacy concerns for the service participant. In some embodiments, the service provider engine 102 itself can also be a service participant if the service provider engine 102 has enough computing resources to provide resilient and stable services.

In some embodiments, one or more of the plurality of service nodes 202 are identified by the service provider engine 102 over the Internet. In some embodiments, one or more of the plurality of service nodes 202 are self-registered by a service participant that owns the one or more service nodes 202 via a service node registry 206 of the service provider engine 102. In some embodiments, the service node registry 206 is configured to accept a registration request of the one or more service nodes 202 by the participant, collect and maintain detailed information about each node device of the one or more service nodes 202 wherein information includes but is not limited to computing and/or storage capacity, communication bandwidth, availability and health of the each node device. In some embodiments, the service node registry 206 is configured to collect a list of computing services offered by the one or more service nodes 202 that are available to the service clients and maintain the set of computing services in a service directory 208. In some embodiments, the service node registry 206 is configured to publish the list of computing services maintained in the service directory 208 to the plurality of service clients so they can choose which computing services are available/offered for access by the service participants.

In some embodiments, a service node cluster manager 210 of the service provider engine 102 is configured to organize and group the plurality of service nodes 202 into one or more scalable service clusters 204s each comprising one or more of the plurality of service nodes 202. In some embodiments, the service node cluster manager 210 is configured to monitor current running condition and/or health of each of the node devices of the one or more service nodes 202 within each service cluster 204. In some embodiments, the service node cluster manager 210 is configured to create one or more logical clusters/pools 212 of logical nodes 214s and map the one or more service nodes 202 within a service cluster 204 to one or more logical nodes 214 within one of the logical clusters 214. In some embodiments, each service node 202 and its node devices may run one or more logical nodes 214 and belong to one or more logical clusters 212. As shown by the example of FIG. 2, logical cluster #1 and #2 have four and three logical nodes, respectively. The logical nodes of each of the logical cluster may run on different node devices while two logical nodes belonging to logical cluster #1 and #2, respectively, may run on a same node device. In some embodiments, the logical nodes 214 within a logical cluster 212 are presented and made available to the plurality of service clients for access while the actual/physical configuration of each logical cluster 212, e.g., number of service nodes 202 and/or service clusters 204 included, is hidden from the plurality of service clients. Given the flexibility of logic service clusters 212, any physical node device 202 may handle more than one service depending on the computing capacity of the node device 202.

Once the list of computing services has been published to the plurality of service clients, a service client may start a request for one of the list of computing services. In some embodiments, the request is published to the logic clusters 212s of logical nodes 214s, creating a competitive fulfillment race. In some embodiments, the first logical service cluster 212/service node 214 responding to fulfill the service request will return a response. In some embodiments, a service/content router 216 of the service provider engine 102 is configured to route communications (e.g., the requests for service and/or the response to the request) between the service client and the first logical service cluster 212/service node 214 that responds to the request. In some embodiments, the service/content router 216 is configured to logically allocate/assign and intelligently route the request for service from the service client to a logical cluster 212 and/or a logical service node 214 depending on current service routing logic of the plurality of logical clusters 212s/logical nodes 214. Here, the service routing logic includes one or more of geolocations, available computing capacities, service types, and current service demands of the plurality of logical clusters 212s/logical nodes 214s and/or the plurality of service nodes 202 and service clusters 204 mapped to them. In some embodiments, the service/content router 216 is configured to constantly receive updates of the latest service routing logic from the service node registry 206.

Once the request has been routed and served by the logical cluster 212/logical node 214, the service/content router 216 is configured to track selection of service and the logical cluster 212/logical node 214 by the service client in real-time and to generate a service delivery selection list comprising one or more of immutable proof-of-work, proof-of-service, proof-of-space, and time of the service that has been provided by the logical cluster 212/logical node 214 and/or the underlying service node 202 and the service cluster 204. In some embodiments, for advanced anti-spoofing and fraud prevention, the service/content router 216 is configured to validate the immutable proofs of the service delivery selection list based on one or more cryptographically-signed receipts originating from one or more trust platform modules in the service node 202 and/or the service cluster 204. In some embodiments, the service/content router 216 is configured to transmit/send the service delivery selection list to a service delivery register 302 of the reward service engine 104 in order to credit/reward the service participant who owns the service node 202 and the service cluster 204. In some embodiments, the service/content router 216 is configured to create an additional receipt based on a feedback from the service client and send the feedback receipt to the service delivery register 302.

In some embodiments, a platform internet adapter 218 of the service provider engine 102 is configured to handle transformation of service content requested by the service client as needed and to deliver a digital response of the content to the service client from the logical cluster 212/logical node 214. In some embodiments, the platform internet adapter 218 is configured to perform one of a protocol-level, a network-level, and another type of network messaging exchange between the service client and the logical cluster 212/logical node 214. Once the response has been successfully delivered, the platform internet adapter 218 is configured to simultaneously create a service/content delivery receipt for the service provided by the logical cluster 212/logical node 214 and send the service receipt to the service delivery register 302 of the reward service engine 104. In some embodiments, the service client is configured to generate a service fulfillment receipt via a tracing app for verifying the service/content requested has been delivered. In some embodiments, the tracing app can be in a form of a piece of injected code or a software agent.

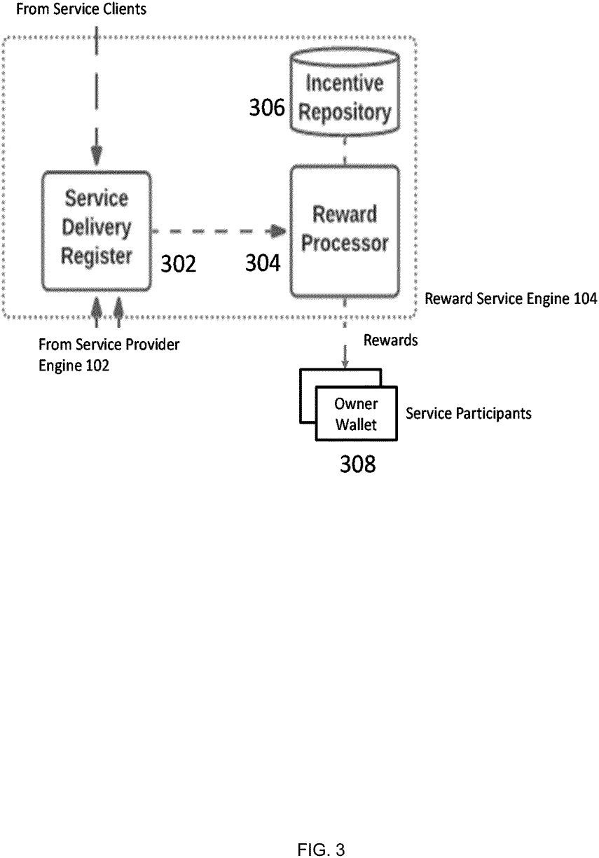

In the example of FIG. 1, the reward service engine 104 is configured to keep track of services provided by each of the plurality of service participants and to reward the plurality of service participants for the services provided. In some embodiments, the reward service engine 104 runs on the same host as the service provider engine 102. In some embodiments, the reward service engine 104 is an independent entity running on a separate host from the service provider engine 102 to increase confidence level for the service participants and the service clients for mutual trust purposes. FIG. 3 depicts an example of components of the reward service engine 104 in the example of FIG. 1. In some embodiments, the service delivery registry 302 of the reward service engine 104 is configured to collect and record a service performed by the service node 202/service cluster 204 owned by a service participant based on the receipts (e.g., service delivery selection list, the feedback receipt, and/or the service receipt) received with digital forensics and validation. A reward processor 304 of the reward service engine 104 is configured to process and determine a reward to the service participant for the service provided, wherein the reward/credit is accumulated for the service participant in an incentive repository 306, where rewards for all of the plurality of participants are maintained (deducted and replenished) based on usage of the services offered by the service participants. Here, the reward/credit can be in the form of a digital currency, a crypto currency, or any form of financial benefits in digital or fiscal form. Depending on a payment schedule or reward frequency or when the rewards for the service participant have accumulated to a pre-defined threshold, the reward processor 304 is configured to distribute the reward from the incentive repository 306 to the service participant by, e.g., depositing the record to an owner (digital) wallet 308 of the service participant. Here, each of a plurality of owner wallets 308s assigned to each of the service participants is a hardware and/or software component configured to maintain the rewards that have been credited to and deposited with the service participant. In some embodiments, each of the service participants may have one or more owner wallets 308s depending on the types of the rewards deposited with the each of the service participants. In some embodiments, the plurality of owner wallets 308s are maintained over the Internet via a block chain.

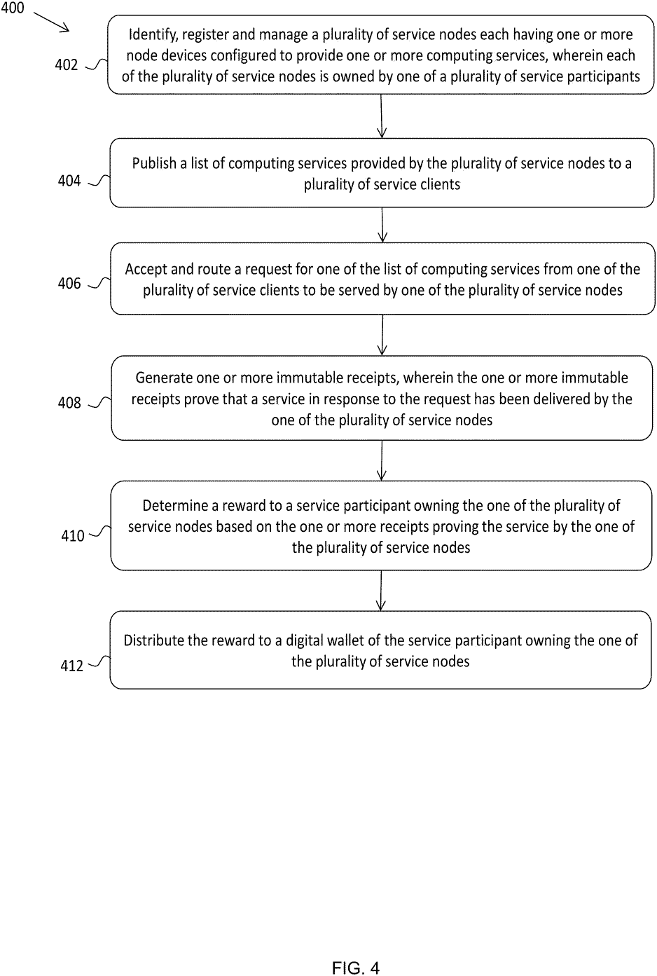

FIG. 4 depicts a flowchart 400 of an example of a process to support a reward-based distributed computing platform. Although the figure depicts functional steps in a particular order for purposes of illustration, the processes are not limited to any particular order or arrangement of steps. One skilled in the relevant art will appreciate that the various steps portrayed in this figure could be omitted, rearranged, combined, and/or adapted in various ways.

In the example of FIG. 4, the flowchart 400 starts at block 402, where a plurality of service nodes each having one or more node devices configured to provide one or more computing services are identified, registered, and managed, wherein each of the plurality of service nodes is owned by one of a plurality of service participants. The flowchart 400 continues to block 404, where a list of computing services provided by the plurality of service nodes is published to a plurality of service clients. The flowchart 400 continues to block 406, where a request for one of the list of computing services is accepted and routed from one of the plurality of service clients to be served by one of the plurality of service nodes. The flowchart 400 continues to block 408, where one or more immutable receipts are generated, wherein the one or more immutable receipts prove that a service in response to the request has been delivered by the one of the plurality of service nodes. The flowchart 400 continues to block 410, where a reward to a service participant owning the one of the plurality of service nodes is determined based on the one or more receipts proving the service by the one of the plurality of service nodes. The flowchart 400 ends at block 412, where the reward is distributed to a digital wallet of the service participant owning the one of the plurality of service nodes.

One embodiment may be implemented using a conventional general purpose or a specialized digital computer or microprocessor(s) programmed according to the teachings of the present disclosure, as will be apparent to those skilled in the computer art. Appropriate software coding can readily be prepared by skilled programmers based on the teachings of the present disclosure, as will be apparent to those skilled in the software art. The invention may also be implemented by the preparation of integrated circuits or by interconnecting an appropriate network of conventional component circuits, as will be readily apparent to those skilled in the art.

The methods and system described herein may be at least partially embodied in the form of computer-implemented processes and apparatus for practicing those processes. The disclosed methods may also be at least partially embodied in the form of tangible, non-transitory machine readable storage media encoded with computer program code. The media may include, for example, RAMs, ROMs, CD-ROMs, DVD-ROMs, BD-ROMs, hard disk drives, flash memories, or any other non-transitory machine-readable storage medium, wherein, when the computer program code is loaded into and executed by a computer, the computer becomes an apparatus for practicing the method. The methods may also be at least partially embodied in the form of a computer into which computer program code is loaded and/or executed, such that, the computer becomes a special purpose computer for practicing the methods. When implemented on a general-purpose processor, the computer program code segments configure the processor to create specific logic circuits. The methods may alternatively be at least partially embodied in a digital signal processor formed of application specific integrated circuits for performing the methods.

What is claimed is:

1. A system, comprising:
a service provider engine configured to
identify, register, and manage a plurality of service nodes each having one or more node devices configured to provide one or more computing services, wherein each of the plurality of service nodes is owned by one of a plurality of service participants;
publish a list of computing services provided by the plurality of service nodes to a plurality of service clients;
accept and route a request for one of the list of computing services from one of the plurality of service clients to be served by one of the plurality of service nodes;
generate one or more immutable receipts, wherein the one or more immutable receipts prove that a service in response to the request has been delivered by the one of the plurality of service nodes;
a reward service engine configured to
determine a reward to a service participant owning the one of the plurality of service nodes based on the one or more receipts proving the service by the one of the plurality of service nodes;
distribute the reward to a digital wallet of the service participant owning the one of the plurality of service nodes.

2. A computer-implemented method, comprising:
identifying, registering, and managing a plurality of service nodes each having one or more node devices configured to provide one or more computing services, wherein each of the plurality of service nodes is owned by one of a plurality of service participants;
publishing a list of computing services provided by the plurality of service nodes to a plurality of service clients;
accepting and routing a request for one of the list of computing services from one of the plurality of service clients to be served by one of the plurality of service nodes;
generating one or more immutable receipts, wherein the one or more immutable receipts prove that a service in response to the request has been delivered by the one of the plurality of service nodes;
determining a reward to a service participant owning the one of the plurality of service nodes based on the one or more receipts proving the service by the one of the plurality of service nodes;
distributing the reward to a digital wallet of the service participant owning the one of the plurality of service nodes.

3. A system, comprising:
a means for identifying, registering, and managing a plurality of service nodes each having one or more node devices configured to provide one or more computing services, wherein each of the plurality of service nodes is owned by one of a plurality of service participants;
a means for publishing a list of computing services provided by the plurality of service nodes to a plurality of service clients;
a means for accepting and routing a request for one of the list of computing services from one of the plurality of service clients to be served by one of the plurality of service nodes;
a means for generating one or more immutable receipts, wherein the one or more immutable receipts prove that a service in response to the request has been delivered by the one of the plurality of service nodes;
a means for determining a reward to a service participant owning the one of the plurality of service nodes based on the one or more receipts proving the service by the one of the plurality of service nodes;
a means for distributing the reward to a digital wallet of the service participant owning the one of the plurality of service nodes.
